(19) United States
(12) Patent Application Publication
(10) Pub. No.: US 2016/0042738 A1
(43) Pub. Date: Feb. 11, 2016

(54) VOICE RECORDING AND PROCESSING APPARATUS FOR USE IN SPEECH-TO-TEXT CONVERSION AND ANALYSIS SYSTEMS

(71) Applicant: Call Audit LLC, Shaker Heights, OH (US)

(72) Inventor: Dmitry Belkin, Shaker Heights, OH (US)

(21) Appl. No.: 14/452,491

(22) Filed: Aug. 5, 2014

(51) Int. Cl. G10L 15/26

(52) U.S. Cl. CPC G10L 15/26

(57) ABSTRACT

Embodiments of the present invention are generally directed towards voice processing systems and methods of use thereof. Specifically, embodiments of the present invention are directed to providing an apparatus for recording and processing of voice data for transmission and use in speech-to-text analysis systems. Preferred embodiments of the present invention provide an apparatus configured to record call data from one or more sources and provide processing and transmission services on the recorded call data that allow for the data to be utilized and consumed in one or more remote speech-to-text analysis systems.

### FIELD OF THE INVENTION

Embodiments of the present invention are generally directed towards voice processing systems and methods of use thereof. Specifically, embodiments of the present invention are directed to providing an apparatus for recording and processing of voice data for transmission and use in speech-to-text analysis systems. Preferred embodiments of the present invention provide an apparatus configured to record call data from one or more sources and provide processing and transmission services on the recorded call data that allow for the data to be utilized and consumed in one or more remote speech-to-text analysis systems.

### BACKGROUND

Call centers, customer service centers, banking institutions, emergency response units, and incalculable organizations of various types all utilize call recording systems in order to allow for review and analysis of calls and call data for various points of information. Whether the review is for compliance purposes, such as ensuring employees are saying and doing what they are expected to on calls with consumers, or other purposes, such as validation or reproduction of call data for later use.

Many of these call systems provide the additional feature of transcribing audio via speech-to-text analysis systems. These speech-to-text analysis systems may include transcription systems, whereby call data is manually transcribed, to fully automated speech-to-text analysis where software and computer hardware work together to provide conversion of call data into text via one or more algorithmic procedures.

However, these systems all require vast network requirements and expensive centralized hardware as voice data is generally fed into a centralized system for processing. In certain cases call data is provided directly to the centralized systems that are setup in between the caller and call recipient via some form of private branch exchange (PBX) system. In other cases, proprietary hardware systems are required to route voice lines in and out of a system that is setup between callers and a call recipient.

Generally speaking, these systems all are demanding on a network as call data can be very large and with numerous transfers occurring on the same network, such as in a call center, it can quickly become a bandwidth issue or cause other bottlenecking issues or require specialized hardware to handle the processing and transfer of call data for usage in the above described systems.

Therefore, there is need in the art for an apparatus that can reduce processing and transmission overhead in speech-to-text conversion and analysis systems as well as methods for using such apparatuses in conjunction with existing speech-to-text analysis systems. These and other features and advantages of the present invention will be explained and will become obvious to one skilled in the art through the summary of the invention that follows.

### SUMMARY OF THE INVENTION

Accordingly, it is an aspect of the present invention to provide an apparatus that can reduce processing and transmission overhead in speech-to-text conversion and analysis systems as well as methods for using such apparatuses in conjunction with existing speech-to-text analysis systems. The following is a summary for providing a solution to the problem in the form of an apparatus configured to receive call data from one or more sources and provide processing, storage and/or transmission services on the received call data in order to allow for the data to be utilized and consumed in one or more remote speech-to-text analysis systems.

According to an embodiment of the present invention, a voice recording and processing apparatus for use in speech-to-text conversion and analysis systems includes: a voice data processing module, comprising computer-executable code stored in non-volatile memory, a voice data transmission and training module, comprising computer-executable code stored in non-volatile memory, a communications module, a processor, one or more input lines, one or more output lines, and one or more storage mediums, wherein said voice data processing module, said voice data transmission and training module, said communications module, said processor, said one or more input lines, said one or more output lines, and said one or more storage mediums are operably connected and are configured to: receive call data; transcribe, in conjunction with configuration data previously provided to the apparatus, said call data into a text based transcription data; and transmit said text based transcription data to a remote computing system.

According to an embodiment of the present invention, the voice data processing module, said voice data transmission and training module, said communications module, said processor, said one or more input lines, said one or more output lines, and said one or more storage mediums are further configured to: operate in a training mode where call data is provided to the remote computing system without being transcribed into said text based transcription data; transfer into an operative mode upon receipt of said configuration data from said remote computing system.

According to an embodiment of the present invention, the communications module is configured to effect wireless transfer of said call data and said transcription data to said remote computing system.

According to an embodiment of the present invention, the voice data processing module, said voice data transmission and training module, said communications module, said processor, said one or more input lines, said one or more output lines, and said one or more storage mediums are further configured to schedule transfer of said call data to said remote computing system.

According to an embodiment of the present invention, the scheduling of said transfer is controlled by configuration data provided to determine optimal times to transfer said call data.

According to an embodiment of the present invention, the optimal times include a time when bandwidth utilization is at a minimum.

According to an embodiment of the present invention, the apparatus is configured to enter a training mode from an operative mode upon receipt of a command from said remote computing system.

According to an embodiment of the present invention, the determination of an accuracy of said text based transcription data is the cause of the switch from said operative mode to said training mode.

According to an embodiment of the present invention, the accuracy is determined by said remote computing system.

According to an embodiment of the present invention, a method for voice recording and processing for use in conjunction with speech-to-text conversion and analysis systems includes the steps of: receiving call data; transcribing, in conjunction with configuration data previously provided to the apparatus, said call data into a text based transcription data; and transmitting, via a communications module, said text based transcription data to a remote computing system.

According to an embodiment of the present invention, the method further comprises the steps of: operating in a training mode where call data is provided to the remote computing system without being transcribed into said text based transcription data; transferring into an operative mode upon receipt of said configuration data from said remote computing system.

According to an embodiment of the present invention, the method further comprises the step of scheduling transfer of said call data to said remote computing system.

According to an embodiment of the present invention, the method further comprises the step of entering a training mode from an operative mode upon receipt of a command from said remote computing system.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates a schematic overview of a computing device, in accordance with an embodiment of the present invention;

FIG. 2A illustrates a schematic of a voice recording and processing apparatus, in accordance with an embodiment of the present invention;

FIG. 2B illustrates a schematic of a voice recording and processing apparatus, in accordance with an embodiment of the present invention;

FIG. 2C illustrates a schematic of a voice recording and processing apparatus, in accordance with an embodiment of the present invention;

FIG. 3 is a process flow of an exemplary method in accordance with embodiments of the present invention; and

FIG. 4 is a process flow of an exemplary method in accordance with embodiments of the present invention.

### DETAILED SPECIFICATION

Embodiments of the present invention are generally directed towards voice processing systems and methods of use thereof. Specifically, embodiments of the present invention are directed to providing au apparatus for recording and processing of voice data for transmission and use in speech-to-text analysis systems. Preferred embodiments of the present invention provide an apparatus configured to record call data from one or more sources and provide processing and transmission services on the recorded call data that allow for the data to be utilized and consumed in one or more remote speech-to-text analysis systems.

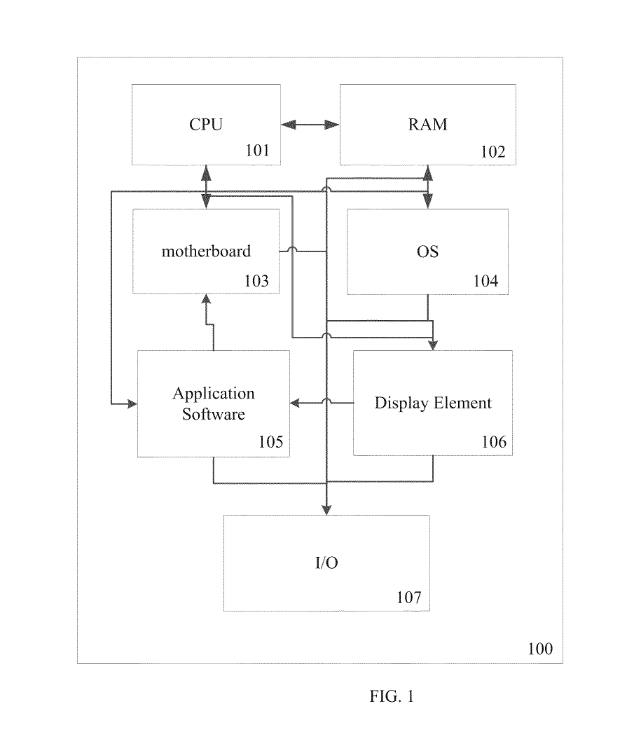

According to an embodiment of the present invention, the apparatus may be accomplished through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, a storage medium (e.g., hard disk drive, solid state drive, flash memory) 103, an operating system (OS) 104, one or more application software 105, one or more display elements 106 and one or more input/output devices/means 107. One of ordinary skill in the art would appreciate that some of these components may be optional, such as the one or more display elements 106. One of ordinary skill in the art would understand that any number of computing devices could be used, and embodiments of the present invention are contemplated for use with any computing device.

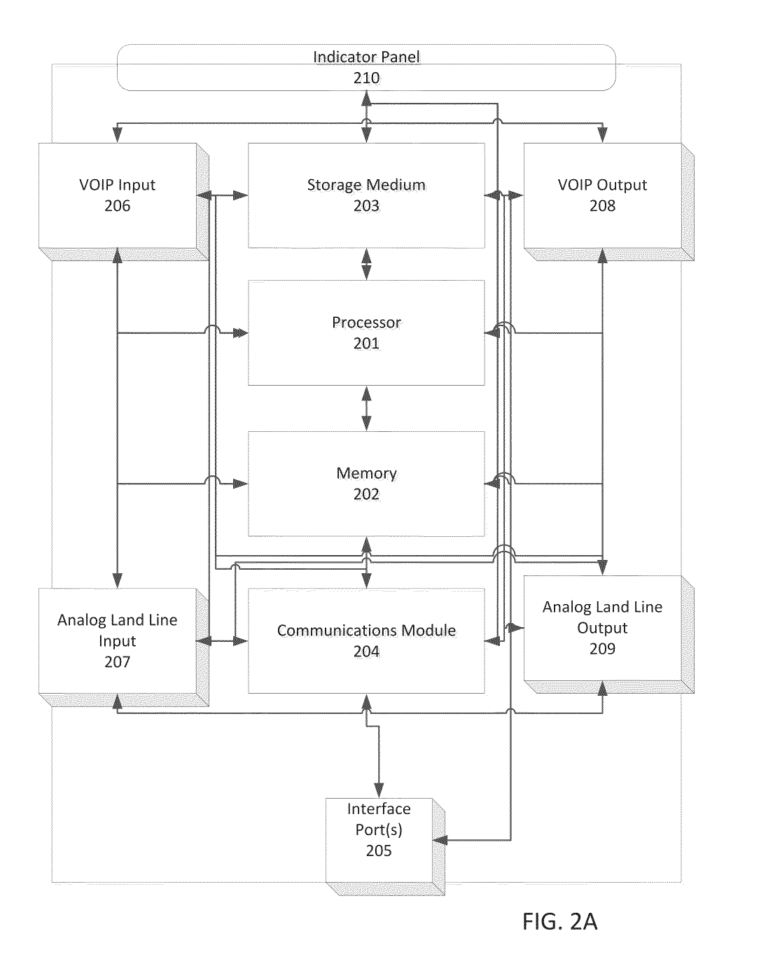

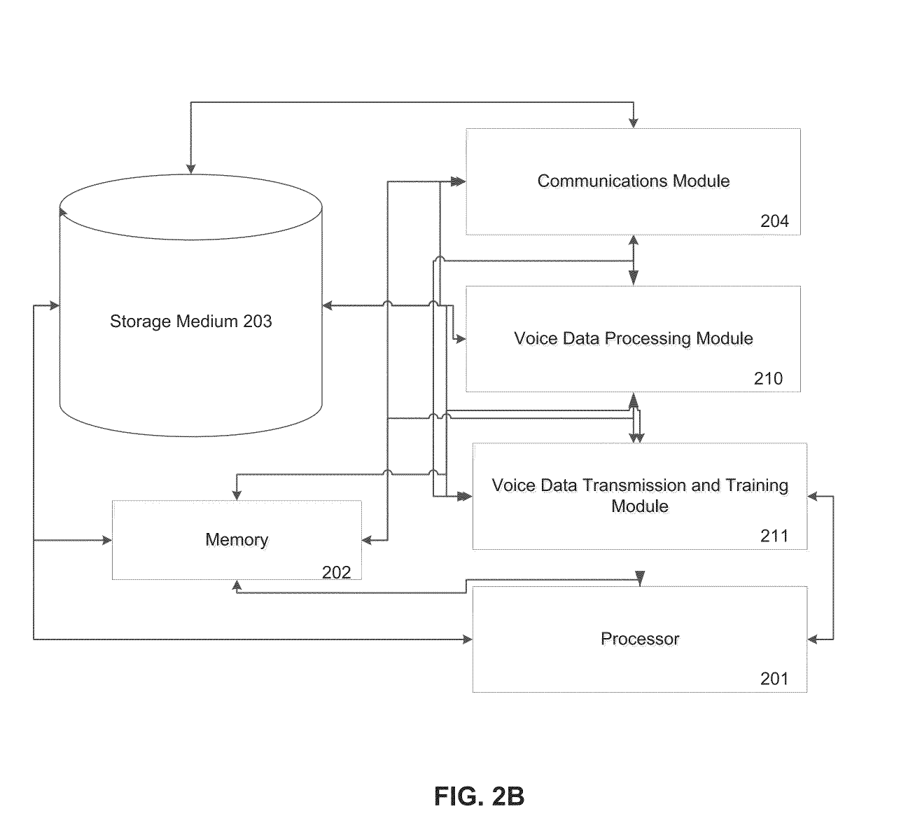

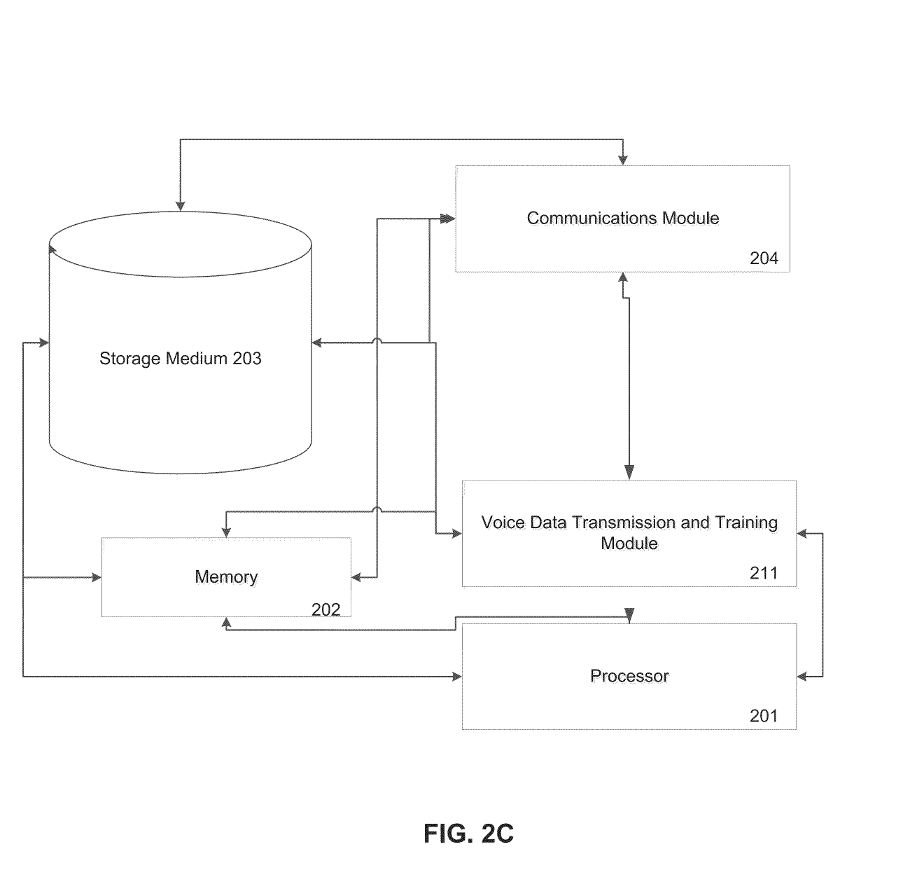

FIG. 2A shows an exemplary embodiment of a voice recording and processing apparatus, in accordance with an embodiment of the present invention. In this embodiment, the apparatus is comprised of one or more processors or processing units 201 (e.g., central processing units, advanced processing units), one or more memory units 202 (e.g., flash memory, random access memory, read only memory units, dynamic random access memory units), one or more storage mediums 203 (e.g., flash drives, solid state drives, hard disk drives, non-transitory random access memory), one or more communications modules 204, one or more interface ports 205, one or more voice over internet protocol (VOIP) inputs 206, one or more analog land line inputs 207, one or more VOIP outputs 208, one or more analog land line outputs 209 and an indicator panel 210. Certain embodiments may have additional or fewer components, depending on the form and format of the apparatus desired. For instance, a voice recording and processing apparatus configured for use only with VOIP lines may exclude the analog inputs 207 and analog outputs 209. Other embodiments may exclude the indicator panel 210 entirely. One of ordinary skill in the art would appreciate that there are numerous configurations that could be utilized with voice recording and processing apparatus in accordance with embodiments of the present invention, and embodiments of the present invention are contemplated for use with any appropriate configuration for a voice recording and processing apparatus.

Turning to FIG. 2B, according to an embodiment of the present invention, the apparatus may be comprised of various components operably and/or communicatively connected with the other components of the apparatus, including, but not limited to a communications module 204, one or more storage mediums 203, a processor 201, memory 202, a voice data processing module 210 and a voice data transmission and training module 211. In FIG. 2C, according to an embodiment of the present invention, the apparatus is comprised of one or more communications modules 204, one or more storage mediums 203, a processor 201, memory 202 and a voice data transmission and training module 211. In alternate embodiments, the apparatus may have additional or fewer components. One of ordinary skill in the art would appreciate that the system may be operable with a number of optional components, and embodiments of the present invention are contemplated for use with any such optional component.

According to an embodiment of the present invention, the communications module of the system may be, for instance, any means for receiving, communicating and/or processing data, voice or video communications over one or more networks or to one or more peripheral devices attached to the apparatus. Appropriate communications modules may include, but are not limited to, wireless connections (e.g., WIFI modules, cellular modules), wired connections, cellular connections, data port connections, BLUETOOTH connections, fiber optic connections, modems, network interface cards or any combination thereof. Moreover, the communications module may be configured to receive communications data from one or more components of the apparatus (e.g., VOIP input 206, analog land line input 207, VOIP output 208, analog land line output 209, interface ports 205) and process the communications data into formats usable by other components of the system, such as the voice data processing module 210 or the voice data transmission and training module 211. One of ordinary skill in the art would appreciate that there are numerous communications modules that may be utilized with embodiments of the present invention, and embodiments of the present invention are contemplated for use with any communications module.

In a preferred embodiment of the present invention, the apparatus will incorporate one or more interface ports for use and interaction with remote systems and communications devices. Interface ports 205 may include, but are not limited to universal serial bus (USB) ports, audio signal ports (e.g., RCA ports, 3.5 mm audio ports, ¼″ audio ports), digital i/o ports, component input ports HDMI ports, serial ports, parallel ports, proprietary data and/or audio ports, Ethernet ports, fiber-optic ports, general purpose input/output (GPIO) ports, or any combination thereof. One of ordinary skill in the art would appreciate that there are numerous types of interface ports that could be utilized with embodiments of the present invention, and embodiments of the present invention are contemplated for use with any appropriate number and types of interface ports. In a preferred embodiment of the present invention, the interface port(s) 205 provide a pathway for data to be transmitted to external elements, such as a remote computing device, a remote speech-to-text conversion and/or analysis system, or any combination thereof.

In an exemplary embodiment according to the present invention, data may be provided to the apparatus, stored by the apparatus and provided by the apparatus to remote computing devices or other systems across networks and systems including, but not limited to, local area networks (LANs) (e.g., office networks, home networks) or wide area networks (WANs) (e.g., the Internet), VOIP lines, analog land lines, fiber optic connections or any combination thereof.

In general, the system and methods provided by the apparatus whether connected to a specific network or not. According to an embodiment of the present invention, some of the applications of the present invention may not be accessible when not connected to a network, however the apparatus may be able to record call data, process call data or otherwise consume and process data offline that will be utilized when the apparatus later connected to a network. For instance, while a data network is unavailable, but an analog land line is still operational, the apparatus may still record and process call data while the data network is unavailable. When the data network becomes available, normal operation may occur.

According to an embodiment of the present invention, a voice data transmission and training module is configured to provide functionality and features with respect to the receipt and transmission of data for the apparatus. Data may include, but is not limited to, voice data, audio data or other data communications (e.g., executable instructions or other programmatic/informatics data). One of ordinary skill in the art would appreciate that the voice data transmission and training module could be configured to be utilized with numerous types of data, and embodiments of the present invention are contemplated for use with any type of data.

According to an embodiment of the present invention, a voice data transmission and training module is further configured to provide functionality and features with respect to the transmission and receipt of training and other configuration data for the system. The module may be configured to transmit and receive configuration and training data from a remote system communicatively connected to the apparatus and configured to provide the apparatus with training and configuration data that will be used by the voice data processing module in is processing of voice data and other data types, especially as it relates to the conversion of voice data to text and the scheduling of data transmissions across one or more networks attached to the apparatus.

According to an embodiment of the present invention, a voice data processing module 210 is configured to receive data from any of the various inputs, communications modules and interface ports and process the data for use in providing the features of functionalities of the apparatus described herein. While the features and functionalities of the various module may be assigned to various modules in particular, one of ordinary skill in the art would appreciate that any number of modules or division of features and functionalities amongst the modules may be utilized, and embodiments of the present invention are contemplated for use with and appropriate division of features and functionalities amongst various modules.

According to an embodiment of the present invention, the indicator panel 210 is provided via one or more indicator lights or other visually perceptible means extruding onto an exterior surface of the apparatus. The indicator panel is configured to allow users or operators of the apparatus to view certain current activity with respect to the apparatus. Indicator lights may show certain status events of the apparatus, such as a green light for powered and everything is OK, a flashing red indicator light for an error, a flashing yellow indicator light when one or more actions is occurring in the apparatus (e.g., processing of data, reading/writing to a storage medium). One of ordinary skill in the art would appreciate that there are numerous uses and visual indications that could be utilized in conjunction with the indicator panel, and embodiments of the present invention are contemplated for use with any such visual indications and usages.

According to an embodiment of the present invention, the apparatus is designed and configured to receive call data from one or more sources and process and transmit the call data and/or the processed data to one or more remote systems, such as one or more servers providing a speech-to-text conversion and analysis portal. In a preferred embodiment, the apparatus is configured to receive call data over one or more VOIP lines or analog land lines. The apparatus further allows for the call data to pass through to a VOIP or analog phone used by a call recipient. Call data may be recorded and processed bi-directionally, with data from the caller being recorded from the input lines and the pass-through or output lines being used to record data from the call recipient. Advantageously, the system can also separate voice data into data provided by the caller and data provided by the recipient (i.e., response data). This allows the apparatus to conveniently separate the voice data into two separate and distinct portions. Other embodiments of the present invention combine the two (or more) call data (i.e., caller data and call recipient data) into a single voice data format.

According to an embodiment of the present invention, call data comprises more than just the voice data of the caller and recipient, but may also include call information and other relevant information. For instance, the apparatus may be configured to identify and store and/or associate with the voice data information about the caller, the recipient and other relevant information. Caller information may include, but is not limited to, caller phone number, caller name, caller time zone, or any combination thereof. Recipient information may include, but is not limited to, a recipient identifier (e.g., if recipient is part of a call center and must log on or otherwise access the apparatus to begin receiving calls—an identifier may be assigned, if a call is directed to the apparatus on a given extension, the recipient may be identified by extension and/or other metrics such as schedule of the recipient and location of the recipient), recipient name, recipient role, or any combination thereof. Other relevant information may include, but is not limited to, call time (i.e., time of day), call duration, disconnecting party, or any combination thereof. One of ordinary skill in the art would appreciate that there are numerous types of caller information, recipient information and other relevant information that could be utilized with embodiments of the present invention, and embodiments of the present invention are contemplated for use with any appropriate type of caller information, recipient information or other relevant information.

According to an embodiment of the present invention, the apparatus (or remote computing system) could use the call information to generate additional metrics and information points that could be utilized to provide additional detail about callers and call statistics for the organization using the apparatus. For instance, the call information could be used to generate list of most/least active callers, most/least active times for calls, most/least active area codes, most/least efficient recipients (e.g., based on call duration), or any combination thereof. One of ordinary skill in the art would appreciate that the call information could be utilized to generate numerous reports and other metrics about callers and recipients, and embodiments of the present invention are contemplated for use with the generation of any appropriate report or metric.

Further advantages of the pass-through model of embodiments of the present apparatus is that the apparatus may be put in series with existing phone lines, whether VOIP or analog. Since this does not require modification of existing telephony systems, organizations can outfit existing phone systems to include speech-to-text processing capabilities without retrofitting their entire telephony system. Embodiments of the apparatus are configured to work with existing phone lines and data networks (e.g., LANs, WANs) in order to provide the full array of speech-to-text recording and processing functionality.

In certain embodiments, the apparatus may provide for multiple phone lines to be processed through a single apparatus. For instance, an apparatus could provide for a 2 line format, 4 line format, 5 line format, or any other number of lines. The onboard processing and storage elements could be increased accordingly to handle, store and process the anticipated amount of data flowing through the apparatus. For instance, in call centers using cubicles, a single apparatus could provide features and functionality to a number of cubicles, lessening the number of wires or other elements to be installed or integrated for proper use.

A first functionality provided by embodiments of the apparatus is the transmission of voice data to a remote computer or computing system (e.g., server(s)). Transmission of the voice data may be done over wired connections (e.g., Ethernet, fiber optic cable, GPIO, USB) or wireless connections (e.g., WIFI, BLUETOOTH). Further, since voice data can be very large in terms of the amount of data contained, the apparatus may be configured to schedule transmission at optimal times, such as times when a business is closed or when a known low-point in bandwidth or other network usage is provided. Transmissions can be further scheduled for frequency, such as daily, weekly, monthly, only on specific days, or any combination thereof. Finally, transmissions may also be scheduled on specific networks, such as only on WIFI or only over a specific wired connection. By allowing for the control of data transmission, the apparatus effectively works to help automatically balance load on individual networks accessible by the apparatus.

Selection and configuration of the scheduling of transmissions may be done via a graphical user interface (GUI) provided over a connection with a remote computing device, whether directly connected to the apparatus (e.g., USB connection) or over one or more networks (e.g., LAN, WAN). In certain embodiments, the apparatus may use internet protocol (IP) addressing to receive or set an IP address for access and communication by a remote computing device. In this manner, a remote computing device can interface with one or more apparatuses via a control GUI or other control interface for the purpose of controlling features of the apparatus, such as, but not limited to, scheduling. Where multiple apparatuses are controlled, the remote computing system can automate the scheduling of the apparatuses such that transmission of data from the individual apparatuses is dispersed over a desirable time period in order to allow for the entire data transmission profile from the apparatuses to have little or no effect on the underlying networks.

A second functionality of embodiments of the apparatus is to provide for the transcription of voice data received from the various inputs and outputs of the apparatus. Since voice data can be extremely large, it is preferred that the apparatus avoid transmission of raw voice data (unless desired by the apparatus, such as for training purposes). By having the apparatus process the raw voice data into text through speech analytic means, the apparatus can be configured to transmit text data in lieu of voice data in order to reduce network load. Text data is miniscule compared to voice data, so a network could handle many orders of magnitude more devices providing just text data as opposed to voice data. Further, since the apparatus only has to handle a limited amount of voice data, expanding a system of apparatuses is easy compared to expanding a centralized system that will handle voice data for an entire organization. Simply adding new apparatuses to the system scales the entire system without requiring reworking or scaling hardware for a central system.

In certain embodiments where there are multiple apparatuses linked to a remote computing system, high voice data volume apparatuses can be configured to off load voice data processing to low voice data volume apparatuses. Impact on the network may need to be balanced in these cases, since transmission of voice data from one apparatus to another apparatus is required, but balancing can be handled by using specific networks, such as ad-hoc wireless networks created between two apparatuses so as to avoid traffic on WIFI networks, WANs or LANS.

According to an embodiment of the present invention, the transcription may be complete or partial transcription processing and can be based on one or more types of speech-to-text processing and analytics. Appropriate transcription types include, but are not limited to, word spotting, phonetic search, speech recognition, or any combination thereof. Each type of transcription offers its own benefits and drawbacks and certain types of transcription may be more applicable than others based on service type, call type and the relevant information to be identified in the process. For instance, word spotting transcription means may be utilized for the processing of voice data where the identification of specific words identified by the system is important. Word spotting allows calls and/or voice data to be screened for specific keywords (e.g., calls that contain a keyword, calls that do not contain a keyword). Advantages of word spotting include limited processing power required to analyze voice data when compared to more complex speech analytic and transcription services. Disadvantages are that the words are not generally taken in any particular context, but rather just identified as present or not present.

Speech to text, or speech recognition, transcription types require processing of an entire voice data file for textual representation of each word uttered by caller and call recipient. The entire text of the voice data file is saved and processing is intensive compared to other types of transcriptions since all data must be processed. The advantages are that the entire transcript of a call is searchable and provided for review. The disadvantage is that it can require a significant amount of processing power to complete speech to text transcription, particularly in high-volume settings.

Phonetic search transcription is a middle ground between keyword and speech to text where voice data is first screened using a keyword type transcription and then processed via a speech to text transcription engine if the voice data meets specified criteria (e.g., certain keywords are identified). The advantages are lowered processing cost, but disadvantaged by the fact that not all voice data is provided for search and review. One of ordinary skill in the art would appreciate that there numerous types of transcription types that could be utilized with embodiments of the present invention and embodiments of the present invention are contemplated for use with any type of transcription.

According to an embodiment of the present invention, the apparatus could be configured to perform one or more types of transcription. In certain embodiments, the apparatus could be configured to switch between transcription types based on certain criteria, such as call volume, bandwidth, processing power or availability of other resources. One of ordinary skill in the art would appreciate that there are numerous criteria on which transcription types could selected and be switched between, and embodiments of the present invention are contemplated for use with any appropriate criteria.

According to an embodiment of the present invention, the apparatus is capable of switching between two or more modes in order to provide training and processing of voice data. In preferred embodiments, the apparatus may be configured to start in a training mode in order to improve the accuracy of the speech analytic means. To improve the speech analytic means, the apparatus may transfer raw voice data to a remote system configured to provide transcription services. Transcription services may be, for instance, performed manually or provided automatically via a previously trained centralized system. It may be important to run these remote transcription services on apparatuses, even where previous configuration data has been provided to an apparatus, in order to account for variables, such as line quality and dialects or other intricacies of voice pattern recognition. This may be especially true when one of the call recipient or caller are repeat users of the apparatus, such that training of the device can account for particular intricacies and voice patterns of that repeat user.

According to an embodiment of the present invention, once the centralized system has been provided enough voice data that it determines the apparatus can be configured to exceed a certain level of accuracy based on the transcription performed on the voice data, the centralized system can provide configuration data to the apparatus for the apparatus to use in transcription of voice data locally on the apparatus.

According to an embodiment of the present invention, once trained, through the provision of configuration data by a centralized or otherwise remote system, the apparatus can be put into a second operative mode, where the apparatus automatically provides transcription of the voice data. In preferred embodiments, this operative mode allows the apparatus to transcribe the voice data is receives and records from calls involving the input lines, output lines, interface ports or any combination thereof. This transcribed data can then be transmitted to a remote computing system or other centralized system or portal for use in speech-to-text analysis. This eliminates the need to send voice data and the apparatus can focus on processing and sending transcribed data, reducing overhead on the network(s). Raw voice data can still be stored on a local storage medium on the apparatus for later scheduled transfer to a central or remote computing system or backup purposes. Where backup purposes are desired, the apparatus can be configured with one or more removable storage mediums, such as flash memory sticks, memory card slots or other standard removable storage mediums. One of ordinary skill in the art would appreciate that there are numerous types of removable storage that could be utilized with embodiments of the present invention, and embodiments of the present invention are contemplated for use with any appropriate removable storage medium.

According to an embodiment of the present invention, the remote computing system or other centralized computing system can use transcribed data provided by the apparatus in conjunction with raw data stored and transferred by the apparatus to assess and retrain the apparatus where necessary. For instance, if the apparatus is first trained and provided configuration data by a remote computing system, and the remote computing system later checks the apparatus for accuracy by comparing transferred transcribed data with transcribed data generated by the remote computing system based on the raw voice data provided by the apparatus, the remote computing system can determine that the accuracy of the apparatus has fallen below a predetermined level and force the apparatus back into a training mode. Checking of accuracy can be automatically processed by the remote computing system (e.g., scheduled, random interval, executed when resource utilization is low) or otherwise initiated by a user of the remote computing system (e.g., initiated by a user who notices errors in a transcription).

According to an embodiment of the present invention, the data transcribed by the apparatus is configured for utilization in various speech-to-text analysis systems. In a preferred embodiment, the apparatus(es) are configured to transfer transcribed data to an offsite or remote analysis system. The offsite analysis system then stores and associates the transcribed data (e.g., by user, by date, by division) such that users (e.g., analytics customers) can run reports and gauge effectiveness of callers and/or call recipients. Reporting and gauging of effectiveness can be used for numerous purposes, including, but not limited to, quality assurance, call agent improvement and return on investment analysis or improvement. One of ordinary skill in the art would appreciate that there are numerous purposes for utilization of the transcribed call data provided by the apparatus, and embodiments of the present invention are contemplated for use with any appropriate purpose or utilization of such transcribed call data.

Exemplary Embodiments

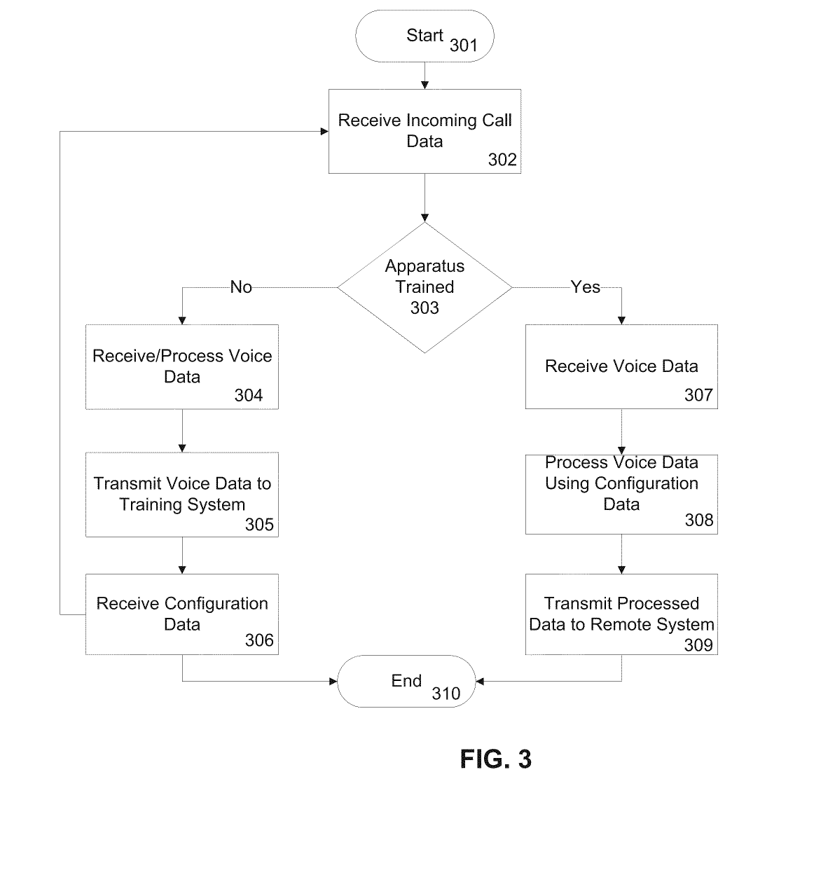

Turning now to FIG. 3, an exemplary process in accordance with the present invention is shown. The process starts at step 301 with the initiation of a call linked to the apparatus. The apparatus receives the call at step 302. At step 303, the apparatus identifies whether it is in a training mode or an operative mode.

If the apparatus is in a training mode, the process moves to step 304 where the apparatus records and processes the voice data. Processing of the voice data at this point may include converting the voice data into an appropriate audio format (e.g., .mp3, .wav) and/or applying codecs and/or compression schemes.

At step 305, the apparatus transmits data to the training system. This may be done immediately or on a schedule. The schedule may be pre-assigned (e.g., night time) or otherwise configured and provided by a remote computing device.

At step 306, the apparatus receives configuration data from the training system. This may occur after the first call or after some specific, predetermined or configured number of calls or duration of voice data provided by the apparatus. At this point the process either loops back to 302 for the receipt of another call or terminates at step 310.

If the apparatus is in operative mode, the apparatus receives the voice data for processing at step 307. At step 308, the apparatus processes the voice data utilizing the previously provided configuration data. Processing at this point generally includes transcription of the voice data into text based data. At step 309, the processed text based data is transmitted to a remote computing system. This may be done immediately or on a schedule. The schedule may be pre-assigned (e.g., night time) or otherwise configured and provided by a remote computing device. At this point the process terminates at step 310.

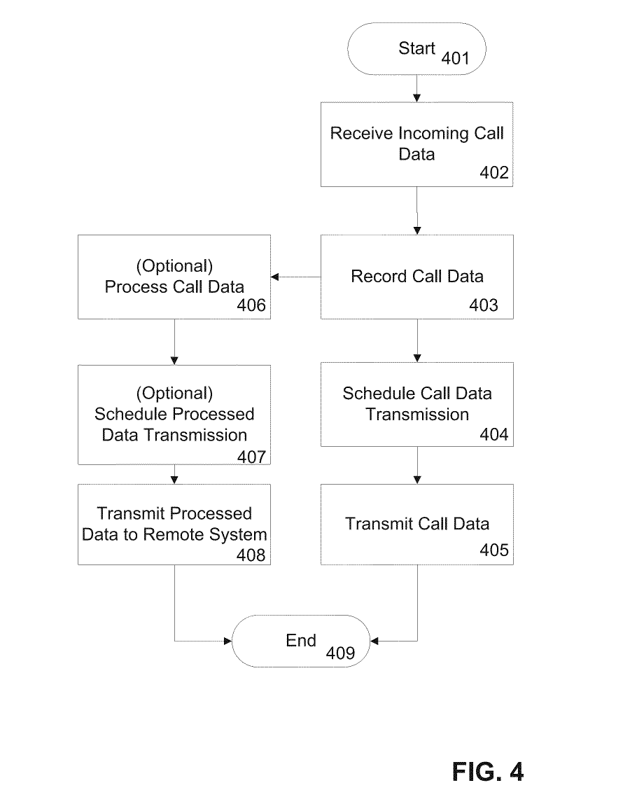

Turning now to FIG. 4, an exemplary process in accordance with the present invention is shown. The process starts at step 401 with the initiation of a call linked to the apparatus. The apparatus receives the call at step 402 and begins to receive incoming call data. At step 403, the apparatus begins to record the call data.

At step 404, the apparatus schedules transmission of the raw call data to a remote computing system or other centralized computing system. Scheduling is generally pre-determined via a configuration of the apparatus, however that configuration may be altered or amended through interaction with a remote computing device or central computing system as described herein.

At step 405, the scheduled time for transmitting the call data occurs and the apparatus transmits the call data to the designed remote computing device or centralized computing system.

Optionally, at step 406, if the apparatus is also configured to transcribe the call data (i.e., apparatus in operative mode), the apparatus may, either in parallel, before or after recording the call data, begin processing of the call data for transcription. Generally this involves using the configuration data contained in the apparatus to process the call data via one or more speech analysis means.

Optionally, at step 407, the transmission of the transcribed data may be scheduled. Upon occurrence of the scheduled time, or alternatively without scheduling, the transcribed data may be transmitted at step 408. Either way, the process then terminates at step 409.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

According to an embodiment of the present invention, a data store may be comprised of one or more of a database, file storage system, relational data storage system or any other data system or structure configured to store data, preferably in a relational manner. In a preferred embodiment of the present invention, the data store may be a relational database, working in conjunction with a relational database management system (RDBMS) for receiving, processing and storing data. In the preferred embodiment, the data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A voice recording and processing apparatus for use in speech-to-text conversion and analysis systems, the apparatus comprising:
a voice data processing module, comprising computer-executable code stored in non-volatile memory,
a voice data transmission and training module, comprising computer-executable code stored in non-volatile memory,
a communications module,
a processor,
one or more input lines,
one or more output lines, and
one or more storage mediums,
wherein said voice data processing module, said voice data transmission and training module, said communications module, said processor, said one or more input lines, said one or more output lines, and said one or more storage mediums are operably connected and are configured to:
receive call data; and
transmit call data to a remote computing system.

2. The apparatus of claim 1, wherein said voice data processing module, said voice data transmission and training module, said communications module, said processor, said one or more input lines, said one or more output lines, and said one or more storage mediums are further configured to:
transcribe, in conjunction with configuration data previously provided to the apparatus from said remote computing system, said call data into a text based transcription data; and
transmit said text based transcription data to said remote computing system.

3. The apparatus of claim 2, wherein said voice data processing module, said voice data transmission and training module, said communications module, said processor, said one or more input lines, said one or more output lines, and said one or more storage mediums are further configured to:
operate in a training mode where call data is provided to the remote computing system without being transcribed into said text based transcription data;
transfer into an operative mode upon receipt of said configuration data from said remote computing system.

4. The apparatus of claim 2, wherein said communications module is configured to effect wireless transfer of said call data and said transcription data to said remote computing system.

5. The apparatus of claim 2, wherein said voice data processing module, said voice data transmission and training module, said communications module, said processor, said one or more input lines, said one or more output lines, and said one or more storage mediums are further configured to schedule transfer of said call data to said remote computing system.

6. The apparatus of claim 5, wherein scheduling of said transfer is controlled by configuration data provided to determine optimal times to transfer said call data.

7. The apparatus of claim 6, wherein said optimal times include a time when bandwidth utilization is at a minimum.

8. The apparatus of claim 2, wherein said apparatus is configured to enter a training mode from an operative mode upon receipt of a command from said remote computing system.

9. The apparatus of claim 8, wherein the determination of an accuracy of said text based transcription data is the cause of the switch from said operative mode to said training mode.

10. The apparatus of claim 9, wherein said accuracy is determined by said remote computing system.

11. A method for voice recording and processing for use in conjunction with speech-to-text conversion and analysis systems, the method comprising the steps of:
receiving call data; and
transmitting call data to a remote computing system.

12. The method of claim 11, further comprising the steps of:
transcribing, in conjunction with configuration data previously provided to the apparatus, said call data into a text based transcription data; and
transmitting, via a communications module, said text based transcription data to a remote computing system.

13. The method of claim 12, further comprising the steps of:
operating in a training mode where call data is provided to the remote computing system without being transcribed into said text based transcription data;
transferring into an operative mode upon receipt of said configuration data from said remote computing system.

14. The method of claim 12, wherein said communications module is configured to effect wireless transfer of said call data and said transcription data to said remote computing system.

15. The method of claim 12, further comprising the step of scheduling transfer of said call data to said remote computing system.

16. The method of claim 15, wherein scheduling of said transfer is controlled by configuration data provided to determine optimal times to transfer said call data.

17. The method of claim 16, wherein said optimal times include a time when bandwidth utilization is at a minimum.

18. The method of claim 12, further comprising the step of entering a training mode from an operative mode upon receipt of a command from said remote computing system.

19. The method of claim 18, wherein the determination of an accuracy of said text based transcription data is the cause of the switch from said operative mode to said training mode.

20. The method of claim 19, wherein said accuracy is determined by said remote computing system.
